(19) United States
(12) Patent Application Publication
(10) Pub. No.: US 2006/0066881 A1
(43) Pub. Date: Mar. 30, 2006

(54) Image input and output device

(75) Inventor: Soo-Hyun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/143,844

(22) Filed: Jun. 3, 2005

(30) Foreign Application Priority Data
Sep. 25, 2004 (KR) 2004-0077598

(51) Int. Cl. G06K 15/10

(52) U.S. Cl. 358/1.8

(57) ABSTRACT

An image input and output device is provided. The image input and output device includes a line-printing type inkjet head having a nozzle unit to eject ink onto paper to print images at a fixed position. The nozzle unit has a length corresponding to a width of the paper. An input device is arranged on an output side of the inkjet head to read images from a document. A supporting member faces the inkjet head and the input device to provide a common moving path to the paper and the document. A moving means moves the paper and the document at a predetermined speed along the common moving path.

### CROSS-REFERENCE TO RELATED APPLICATIONS

This application claims the benefit under 35 U.S.C. 119(a) of Korean Patent Application No. 10-2004-0077598, filed on Sep. 25, 2004, the entire disclosure of which is hereby incorporated by reference.

### BACKGROUND OF THE INVENTION

1. Field of the Invention

The present invention relates to an image input and output device. More particularly, the present invention relates to an input and output device having a common moving means for printing and scanning.

2. Description of Related Art

An image input and output device is typically referred to as a multifunctional product. However, it is not clearly defined whether the multifunction product includes fax transmissions, fax receipt, and/or copying functions. Therefore, in this specification, the term “image input and output device” refers to a device having a printing device and an input device irrespective of fax transmission, receipt, and/or copying functions.

In a conventional image input and output device, a sheet of paper moves along a paper moving path for printing and a document moves along a separate document path for scanning. Therefore, the conventional image input and output device includes both a paper moving means to move the paper for printing and a document moving means to move the document for scanning separately.

Accordingly, there is a need for an image input and output device which is minimal in size and simultaneously simplifies paper and document moving paths.

### SUMMARY OF THE INVENTION

An aspect of the present invention is to solve at least the above problems and/or disadvantages and to provide at least the advantages described below.

Accordingly, an aspect of the present invention is to provide a minimized image input and output device which simplifies a moving path for a paper and a document.

According to an aspect of the present invention, there is provided an image input and output device comprising a line-printing type inkjet head having a nozzle unit to eject inks onto paper to print images at a fixed position. The nozzle unit has a length corresponding to a width of the paper. An input device is arranged on an output side of the inkjet head to read images from a document. A supporting member faces the inkjet head and the input device to provide a common moving path to the paper and the document. A moving means moves the paper and the document at a predetermined speed along the common moving path.

A white plate also may be arranged to face the input device of the supporting member.

The image input and output device may further include a document supplying means to supply the document to the moving means and a paper supplying means to supply the paper to the moving means.

The image input and output device may further include a print error detection means to read test patterns with the input device to detect a missing nozzle and to read alignment in a subscanning direction. The test patterns include at least one main scanning line and at least one subscanning line printed on the paper by the inkjet head.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a perspective view showing an image input and output device in accordance with an embodiment of the present invention;

FIG. 2 is a side elevational view of the image input and output device shown in FIG. 1, in accordance with an embodiment of the present invention;

FIGS. 3A, 3B, 4A and 4B are diagrams showing exemplary arrangements of a nozzle unit;

FIG. 5 is a side elevational view showing a modified example of a paper supplying means;

FIG. 6 is a schematic diagram showing an image input and output device in accordance with another embodiment of the present invention;

FIG. 7 is a diagram showing an example of test patterns; and

FIG. 8 is a diagram showing an example of detected test patterns.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for purposes of clarity and conciseness.

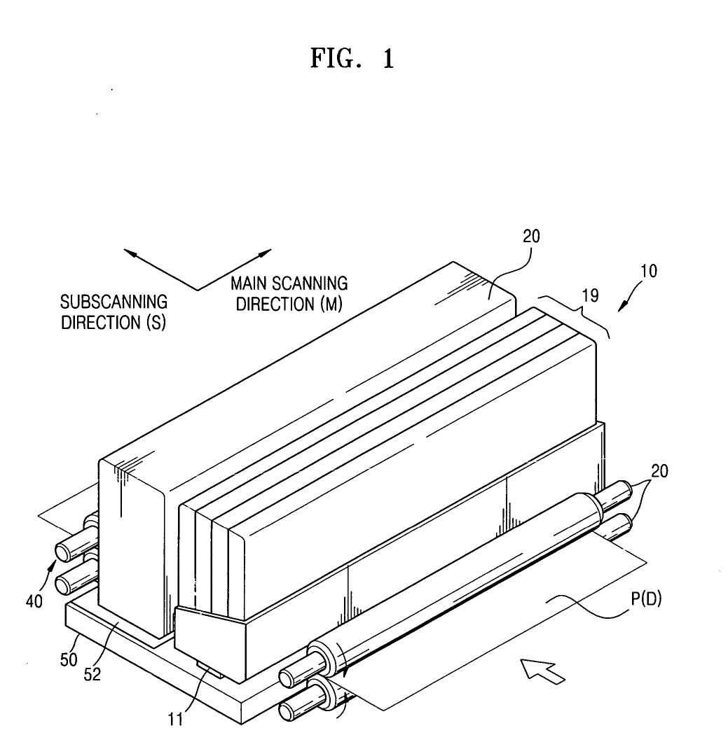

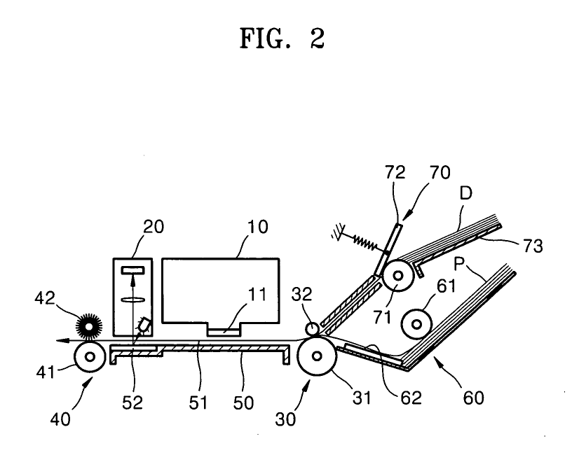

FIGS. 1 and 2 are perspective and side elevational views showing an image input and output device according to an embodiment of the present invention, respectively. Referring to FIGS. 1 and 2, an input device 20 is arranged on an output side of an inkjet head 10.

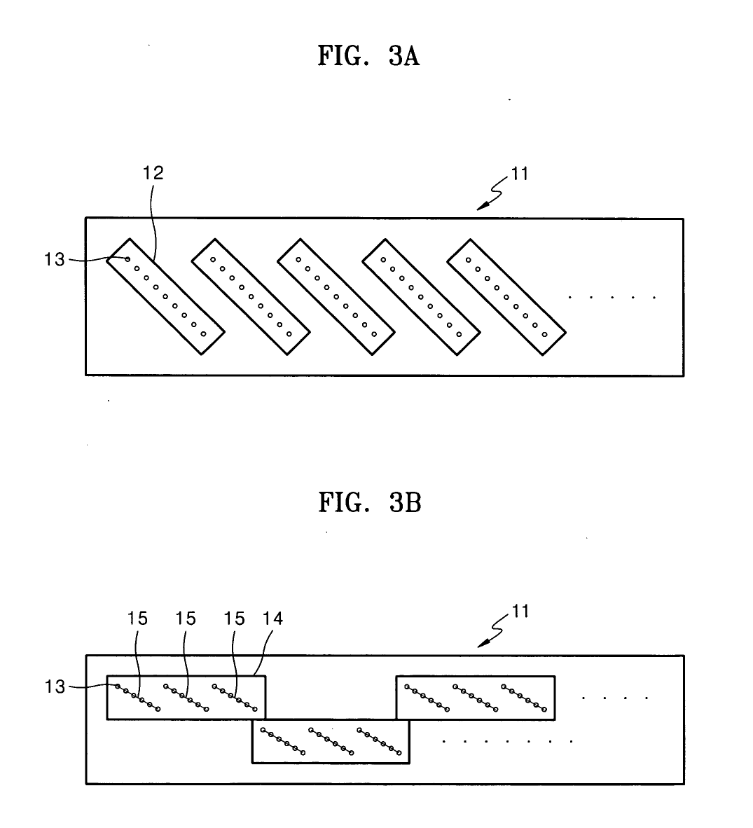

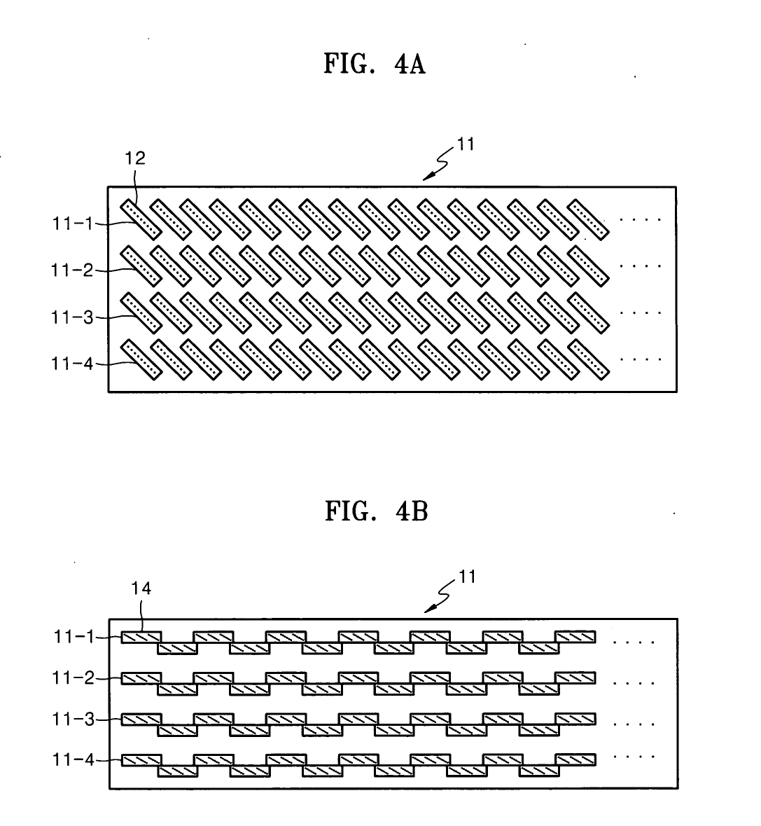

While the conventional inkjet head reciprocates in the direction of a width of a sheet of paper P to eject ink on the paper P, the inkjet head 10 of the present embodiment, referred to as ‘a line-printing type inkjet head’, ejects ink on the paper P at a fixed position. The inkjet head 10 of the present embodiment includes a nozzle unit 11 having a length corresponding to the width of the paper P in a main scanning direction M. FIGS. 3A, 3B, 4A and 4B are diagrams showing exemplary arrangements of the nozzle unit 11. The nozzle unit 11 shown in FIG. 3A is arranged with tilted nozzle plates 12 in the main scanning direction M. Each nozzle plate 12 includes a plurality of nozzles 13 arranged in a row. The nozzle unit 11 shown in FIG. 3B is arranged with two alternating rows of nozzle plates 14. Each nozzle plate 14 includes a plurality of tilted nozzle columns 15. The nozzle unit 11 shown in FIGS. 4A and 4B includes four rows of nozzle sections 11-1, 11-2, 11-3 and 11-4 arranged in the moving direction of the paper P. Each of the nozzle sections 11-1, 11-2, 11-3, and 11-4 may eject the same or different colored inks (e.g., cyan, magenta, yellow, and black colored inks). The nozzle units 11 shown in FIGS. 3A, 3B, 4A, and 4B are just illustrative, and other suitable arrangements and constructions may be used. An interval between the nozzles 13 in the main scanning direction M represents a resolution of the inkjet head 10. Inks are contained in ink cartridges 19. To display color images, four ink cartridges 19 containing cyan, magenta, yellow, and black colored inks are required. Here, the cyan, magenta, yellow and black colored inks are supplied to a plurality of nozzle columns 11-1, 11-2, 11-3, and 11-4. Although not shown, the inkjet head 10 further includes a chamber having an ejecting means (e.g., a piezoelectric device, a heater) connected to respective nozzles 13 to apply a pressure to eject ink. The inkjet head 10 also includes a flowing path along which the inks are supplied from the ink cartridge 19 to the chamber. The chamber, the ejecting means, and the flowing path are well known to those skilled in the art, so a detailed description thereof will be omitted for clarity and conciseness.

The image input and output device of the present embodiment is directed to simplifying a driving unit. Thus, a contact type image sensor (CIS) or a charge coupled device (CCD), which can input line images, may be used as the input device 20. As a document D is moved, the input device 20 reads images from the document D at the fixed position. Arrangements and operations of the CIS and CCD are well known to those skilled in the art, so that the detailed description thereof will be omitted for clarity and conciseness.

A supporting member 50 is separated from the inkjet head 10 and the input device 20 by a predetermined distance to provide a common moving path 51 to the paper P and the document D. The supporting member 50 supports a bottom face of the paper P. Thus, an interval between a top face of the paper P and the nozzle unit 11 is maintained. The interval is preferably about 0.5 to 2 mm. In the image input and output device according to an embodiment of the present invention, the paper P and the document D are moved along the common moving path 51. The supporting member 50 supports a bottom face of the document D. Thus, an interval between the top face of the document D and the input device 20 is maintained. Preferably, a white plate 52 is arranged to face the input device 20 of the supporting member 50. The white plate 52 is used to match white balance of the input device 20.

A moving means 30 is arranged on an input side of the inkjet head 10 to move the paper P and the document D. Preferably, the moving means 30 includes a feed roller 31 and an idle roller 32. The idle roller 32 contacts with and is driven by the feed roller 31. A discharging means 40 is arranged on an output side of the input device 20. The discharging means 40 includes a discharging roller 41 and a star wheel 42 to contact with and rotate with reference to the discharging roller 41. The star wheel 42 also comes into point-contact with the top faces of the paper P and the document D.

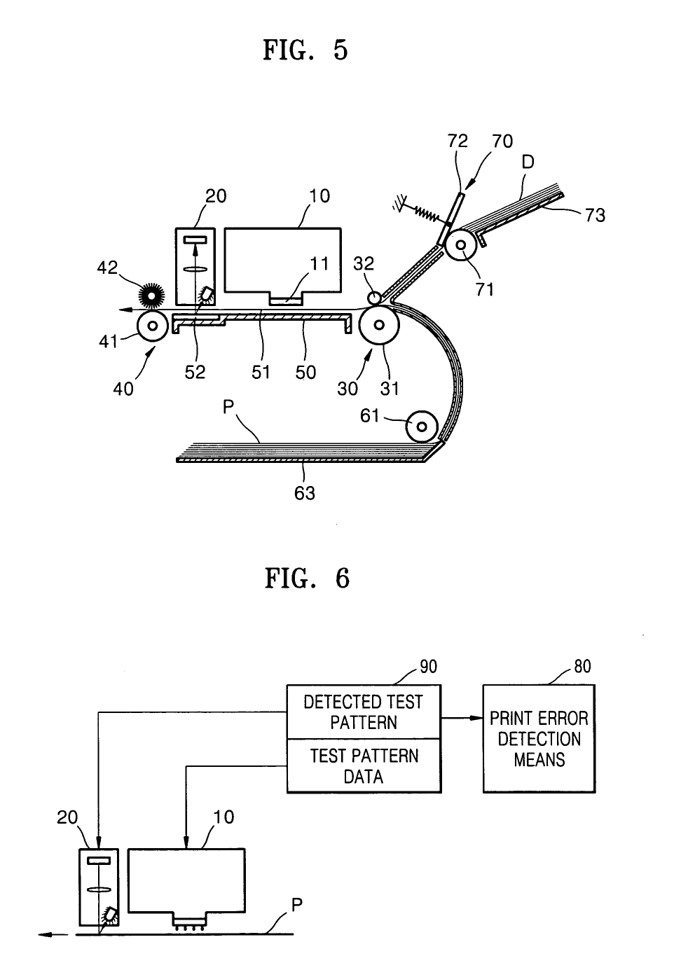

A paper supplying means 60 is arranged to provide the paper P to the moving means 30. As an example, the paper supplying means 60 includes a stack tray 63 where the papers P are stacked, an auto sheet feed (ASF) roller 61 to move the paper P, and a separation member 62 to contact with a front end of the paper P to separate every sheet of the paper P. As shown in FIG. 2, the paper moving means 60 is preferably a bin type arrangement and provides a substantially L-shaped paper moving path. Alternatively, as shown in FIG. 5, the paper moving means 60 may be arranged under the supporting member 50 to provide a substantially U-shaped paper moving path.

Since both the paper P and the document D are sheet-type media, the document D may be supplied to the moving means 30 by using the paper moving means 60. However, to stack the documents D in the bin type or cassette type paper moving means 60, the bin or cassette typically is separated from the image input and output device. This is inconvenient for a user. Therefore, as shown in FIGS. 2 and 5, it is preferable that the image input and output device further include a document supplying means 70 to supply the document D to the moving means 30. For example, the document moving means 70 includes a stack tray 73 where the documents D are stacked, an ADF roller 71 to move the document D, and a friction member 72 to elastically contact with the ADF roller 71 to separate every sheet of document D.

When print information, along with a print signal, is received from a host computer (not shown), the document moving means 60 takes out the paper P from the stack tray 63 to supply to the moving means 30. The moving means 30 moves the paper P along the moving path 51. The inkjet head 10 ejects the ink on the top face of the paper P to print images. The printed paper P is discharged by the discharging means 40. For example, when the user presses an image input button (not shown) of a control panel or inputs an image input command through a host computer, the document moving means 70 takes out the document D from the stack tray 73 to supply to the moving means 30. The moving means 30 moves the document D along the moving path 51. For example, the input device 20 reads image information, which is recorded on the document D, by illuminating a light onto the document D to detect a reflected light signal. The image information is stored into, for example, the storage device of the host computer (not shown) or the storage device of the image input and output device (90 of FIG. 6).

Line-printing type inkjet heads 10 typically print images on the paper P at a fixed position. The input device 20 inputs line images at a fixed position and the moving means 30 moves the paper P and the document D along the common moving path 51. Thus, the image input and output device may be implemented in a relatively simple arrangement.

As shown in FIGS. 3A and 3B, the nozzle unit 11 may include a plurality of nozzles 14 in the main scanning direction M. To obtain print images having relatively good quality, all of the nozzles 13 preferably eject ink. In case that one of the nozzles 13 is blocked, the ink is not ejected in a continuous fashion. Thus, the main scanning lines cannot be printed. Alternatively, when the area surrounding the nozzle 13 is contaminated with dirt or hardened inks, ink is may not be ejected in a desired direction or may be dispersed by colliding with the dirt or hardened ink. Therefore, the continuous main scanning lines cannot be printed. Alternatively, as shown in FIGS. 4A and 4B, the nozzle unit 11 may include a plurality of nozzle columns 11-1, 11 -2, 11-3, and 11-4 arranged in parallel in the subscanning direction S. Here, the subscanning line provided by the nozzle columns 11-1, 11-2, 11-3, and 11-4 should be exactly overlapped to print color images having relatively good quality. The nozzles 13 of the respective nozzle columns 11-1, 11-2, 11-3, and 11-4 are preferably arranged in straight lines. However, during the fabrication process of the nozzle unit 11, the respective nozzle columns may sometimes be obviated or misaligned in the main scanning direction M. As shown in FIG. 6, to detect a missing nozzle and/or misalignment in the subscanning direction, the image input and output device may further include a print error detection means 80. Here, the missing nozzle refers to a nozzle through which the ink cannot be ejected due to the dirt or hardened ink. The alignment in the subscanning direction S refers to a degree of obviation in the respective nozzle columns 11-1, 11-2, 11-3, and 11-4 from the main scanning direction M.

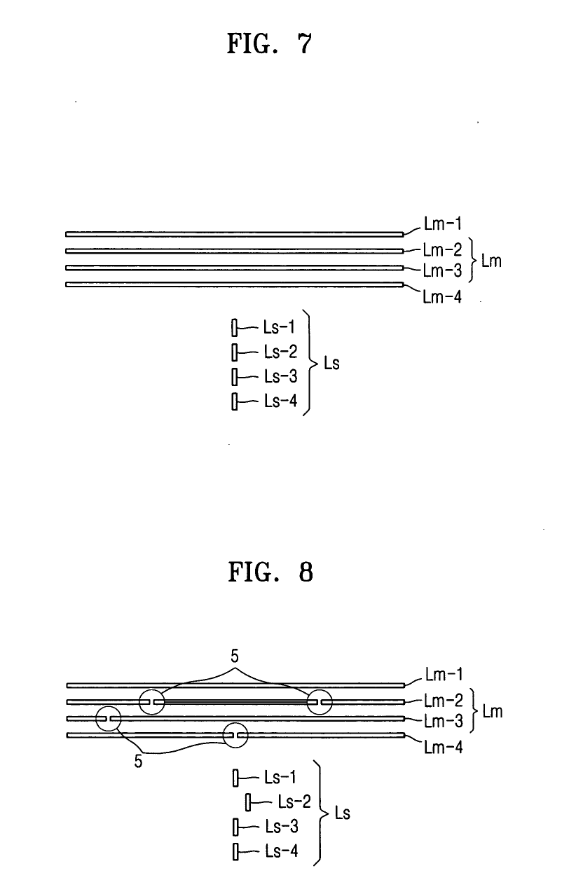

To detect the print error, test pattern data stored in a storage device 90 of the image input and output device or a storage device (not shown) of the host computer is input to the inkjet head 10. The inkjet head 10 prints the test pattern on the paper P. As shown in FIG. 7, the test pattern includes main scanning lines Lm and subscanning lines Ls. According to the embodiment of the present invention, the main scanning lines include cyan, magenta, yellow, and black colored main scanning lines Lm-1, Lm-2, Lm-3, and Lm-4. The main scanning lines are printed by the nozzle columns 11-1, 11-2, 11-3, and 11-4, respectively. The subscanning lines Ls include cyan, magenta, yellow, and black colored subscanning lines Ls-1, Ls-3, Ls-3, and Ls-4, printed by the nozzle columns 11-1, 11-2, 11-3, and 11-4, respectively. When the paper having the test pattern printed thereon passes under the input means 20, the input means 20 illuminates a light onto paper P to detect the test pattern. The detected test pattern is stored into, for example, the storage device 90. Based on the detected test pattern, the print error detection means 80 determines whether the main scanning lines Lm and the subscanning lines Ls are arranged continuously. The print error detection means 80 is, for example, a central processing unit of the image input and output device. Thus, the print error detection means 80 controls operations for printing images and inputting image information.

FIG. 8 is a diagram showing an example of detected test patterns. In a case where the main scanning line Lm-1 is detected to be continuous in the main scanning direction M, it is indicated that there is no missing nozzle in the nozzle column 11-1. In case that the main scanning lines Lm-2, Lm-3, and Lm-4 are detected to have a discontinuous portion 5, it is indicated that the nozzle corresponding to the discontinuous portion 5 is blocked or contaminated. In a case where there is no misalignment error in the subscanning direction S, the subscanning line Ls of the detected test pattern will be a straight line in the subscanning direction S, as shown in FIG. 7. In case that the subscanning lines Ls-2 of the detected test pattern is obviated in the main scanning direction M from other subscanning lines Ls-1, Ls-3, and Ls-4, it is indicated that there is an alignment error in the nozzle column 11-2. In other words, it is indicated that the nozzle column 11-2 is shifted on the whole in the main scanning direction M. The print error detection means 80 detects the amount of shift of the nozzle column 11-2 as an alignment error of the subscanning direction S.

When the missing nozzle is detected, a cleaning means (not shown) removes the ink by force via the nozzle columns 11-1, 11-2, 11-3, and 11-4 to clean the blocked nozzle or to polish the nozzle columns 11-1, 11-2, 11-3, and 11-4 to clean contaminants. When the alignment error in the subscanning direction S is detected, the image data corresponding to, for example, the nozzle column 11-2 is shifted on the whole in the direction opposite to the direction of the alignment error to compensate the alignment error. Typically, the user checks the printed test pattern to see if there is a missing nozzle or an error in the subscanning direction S. If so, the user performs cleaning operations by pressing a button or performs compensation operation by directly inputting the amount of shift to compensate the alignment error. However, in accordance with an embodiment of the present invention, the print error can be automatically detected and compensated, by using the image input and output device having the inkjet head 10, the input device 20, and the print error detection means 80.

As described above, according to the image input and output device of embodiments of the present invention, a document and a paper are moved along a common path by a common moving means. Therefore, the image input and output device can be implemented in a relatively simple arrangement. With an inkjet head and an input device performing printing and image inputting operation at fixed positions, respectively, the image input and output device may further simplified.

With a print error detection means, a print error can be automatically detected and compensated. Therefore, user convenience may be improved.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An image input and output device comprising:
a line-printing type inkjet head having a nozzle unit to eject ink onto paper to print images at a fixed position, the nozzle unit having a length corresponding to the width of the paper;
an input device arranged on an output side of the inkjet head to read images from a document;
a supporting member facing the inkjet head and the input device to provide a common moving path to the paper and the document; and
a moving member to move the paper and the document at a predetermined speed along the common moving path.

2. The image input and output device according to claim 1, wherein a white plate is arranged to face the input device of the supporting member.

3. The image input and output device according to claim 1, further comprising:
a document supplying member to supply the document to the moving member; and
a paper supplying member to supply the paper to the moving member.

4. The image input and output device according to claim 1, further comprising:
a print error detection assembly to read test patterns with the input device to detect a missing nozzle and misalignment in a subscanning direction,
wherein the test patterns include at least one main scanning line and at least one subscanning line printed on the paper by the inkjet head.

5. An image input and output device comprising:
a line-printing type inkjet head having a nozzle unit to eject ink onto paper to print images at a fixed position, the nozzle unit having a length corresponding to the width of the paper;
an input device arranged on an output side of the inkjet head to read images from a document;
a supporting member facing the inkjet head and the input device to provide a common moving path to the paper and the document;
a moving member to move the paper and the document at a predetermined speed along the common moving path; and
a print error detection assembly to read test patterns with the input device to detect a missing nozzle and misalignment in a subscanning direction.

6. The image input and output device according to claim 5, wherein a white plate is arranged to face the input device of the supporting member.

7. The image input and output device according to claim 5, further comprising:
a document supplying member to supply the document to the moving member; and
a paper supplying member to supply the paper to the moving member.

8. The image input and output device according to claim 6, wherein
the test patterns include at least one main scanning line and at least one subscanning line printed on the paper by the inkjet head.

9. An image input and output device comprising:
a line-printing type inkjet head having a nozzle unit to eject ink onto paper to print images at a fixed position, the nozzle unit having a length corresponding to the width of the paper;
an input device arranged on an output side of the inkjet head to read images from a document;
a supporting member facing the inkjet head and the input device to provide a common moving path to the paper and the document;
a moving member to move the paper and the document at a predetermined speed along the common moving path; and
a document supplying member to supply the document to the moving member.

10. The image input and output device according to claim 9, wherein a white plate is arranged to face the input device of the supporting member.

11. The image input and output device according to claim 10, further comprising:
a paper supplying member to supply the paper to the moving member.

12. The image input and output device according to claim 11, further comprising:
a print error detection assembly to read test patterns with the input device to detect a missing nozzle and misalignment in a subscanning direction,
wherein the test patterns include at least one main scanning line and at least one subscanning line printed on the paper by the inkjet head.
